(19) United States
(12) Patent Application Publication
(10) Pub. No.: US 2011/0304788 A1
(43) Pub. Date: Dec. 15, 2011

(54) NONVOLATILE LIQUID CRYSTAL DISPLAY DEVICE AND DISPLAY METHOD FOR NONVOLATILE LIQUID CRYSTAL DISPLAY DEVICE

(75) Inventor: Yuji Ueno, Inagi (JP)

(73) Assignee: FUJITSU FRONTECH LIMITED, Tokyo (JP)

(21) Appl. No.: 13/215,380

(22) Filed: Aug. 23, 2011

Related U.S. Application Data
(63) Continuation of application No. PCT/JP2009/001215, filed on Mar. 18, 2009.

(51) Int. Cl. G02F 1/133

(52) U.S. Cl. 349/33

(57) ABSTRACT

A nonvolatile liquid crystal display device includes: a liquid crystal display panel including a scanning signal line group, a data signal line group intersecting the scanning signal line group, and a plurality of pixel circuits arranged at positions where the signal line groups intersect with each other, and containing a nonvolatile liquid crystal compound as a liquid crystal layer; a scanning signal line driving unit sequentially driving the scanning signal line group; and a controlling unit supplying a selected voltage and a non-selected voltage to the scanning signal line driving unit. In the nonvolatile liquid crystal display device, the controlling unit supplies the non-selected voltage, for a predetermined duration before and after the selected voltage is supplied, respectively to all of scanning signal lines configuring the scanning signal line group.

### CROSS-REFERENCE TO RELATED APPLICATIONS

This application is a continuation of PCT application PCT/JP2009/001215 which was filed on Mar. 18, 2009, the entire contents of which are incorporated herein by reference.

### FIELD

The present invention relates to a liquid crystal display device for displaying an image by driving a liquid crystal, and more particularly, to a nonvolatile liquid crystal display device having a memory characteristic available to electronic paper or the like, and a display method for the nonvolatile liquid crystal display device.

### BACKGROUND

Conventionally, liquid crystal display devices, where a liquid crystal compound is filled between a scanning signal line group and a data signal line group, which configure a matrix, for displaying image information by forming many pixels at intersections between the scanning signal line group and the data signal line group are well known. Among others, for example, a cholesteric liquid crystal display device used for electronic paper or the like has an advantage of having a memory characteristic such that display contents do not disappear even though the device is powered off.

FIGS. 1A, 1B, 1C and 1D are explanatory views of states of a cholesteric liquid crystal.

The cholesteric liquid crystal display device controls a display depending on an alignment of liquid crystal molecules of the device. The states of the cholesteric liquid crystal include a planar state (FIG. 1A) where incident light is reflected, and a focal conic state (FIGS. 1B and 1C) where incident light is transmitted. These states stably exist even under zero electric field. In the planar state, light having a wavelength according to a helical pitch of liquid crystal molecules is reflected.

If a high electric field is applied to a cholesteric liquid crystal, a helical structure of liquid crystal molecules is completely unwound, and the liquid crystal enters a homeotropic state (FIG. 1D) where all the molecules are aligned in a direction of the electric field. Next, if the electric field is rapidly reduced to 0 from the homeotropic state, a helical axis of the liquid crystal becomes vertical to electrodes, and the liquid crystal enters a planar state (FIG. 1A) where light according to a helical pitch is selectively reflected.

In the meantime, if a low electric field having an intensity such that the helical structure of liquid crystal molecules is not unwound is removed after being formed, or if a high electric field is applied and moderately removed, the helical axis of the liquid crystal becomes parallel to the electrode, so that the liquid crystal enters the focal conic state (FIG. 1B) where incident light is transmitted.

Alternatively, if an electric field having a medium intensity is rapidly removed after being applied, the planar state and the focal conic state coexist, enabling a halftone display.

Cholesteric liquid crystal display devices display image information by using the above described phenomena (For example, see Patent Document 1).

Patent Document 1: Japanese Laid-open Patent Publication No. 2001-228459

### SUMMARY

According to one aspect of the present invention, a nonvolatile liquid crystal display device includes: a liquid crystal display panel including a scanning signal line group, a data signal line group intersecting the scanning signal line group, and a plurality of pixel circuits arranged at positions where the signal line groups intersect with each other, and containing a nonvolatile liquid crystal compound as a liquid crystal layer; scanning signal line driving means for sequentially driving the scanning signal line group; and controlling means for supplying a selected voltage and a non-selected voltage to the scanning signal line driving means. In the nonvolatile liquid crystal display device, the controlling means supplies the non-selected voltage, for a predetermined duration before and after the selected voltage is supplied, respectively to all of scanning signal lines configuring the scanning signal line group.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIGS. 1A, 1B, 1C and 1D are explanatory views of states of a cholesteric liquid crystal;

FIG. 2 is an explanatory view of a problem (No. 1) of conventional technology;

FIG. 3 is an explanatory view of a problem (No. 2) of the conventional technology;

FIGS. 4A, 4B and 4C are explanatory views of a first embodiment to which the present invention is applied; FIGS. 5A, 5B and 5C are explanatory views of a second embodiment to which the present invention is applied; and

FIG. 6 is a flowchart illustrating a flow of a display control process in the second embodiment to which the present invention is applied.

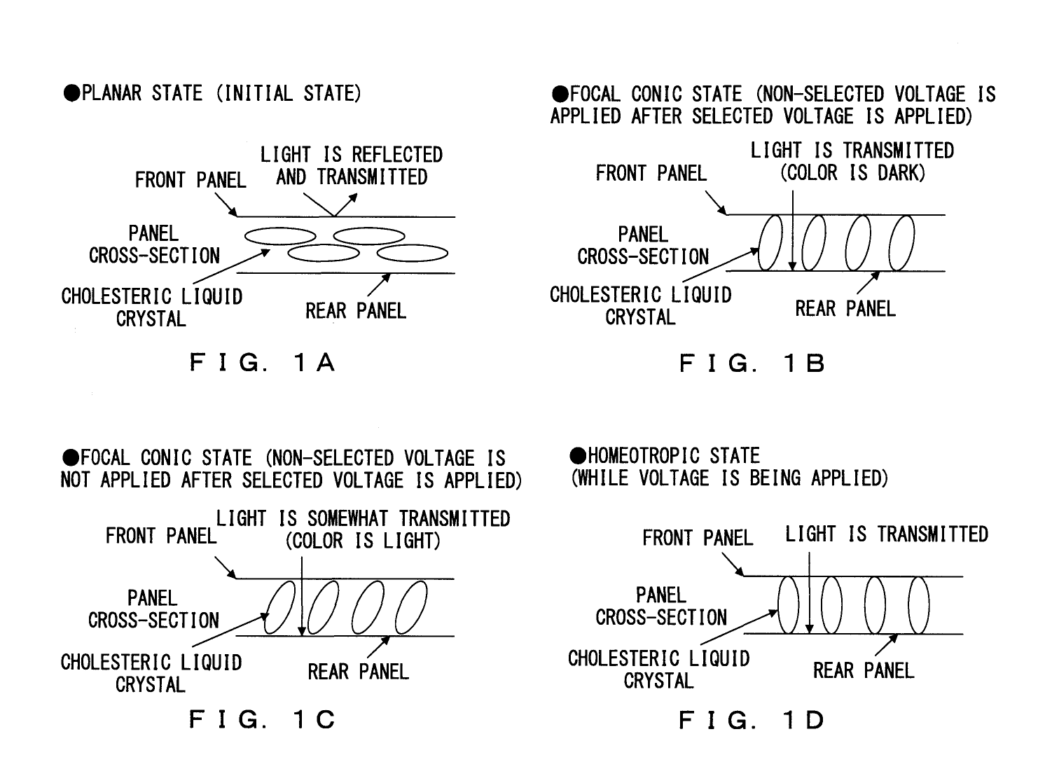

### DESCRIPTION OF EMBODIMENTS

Conventionally, cholesteric liquid crystal display devices have the following problems.

1. Screen Unevenness of a Display Panel when an Entire Screen is Displayed

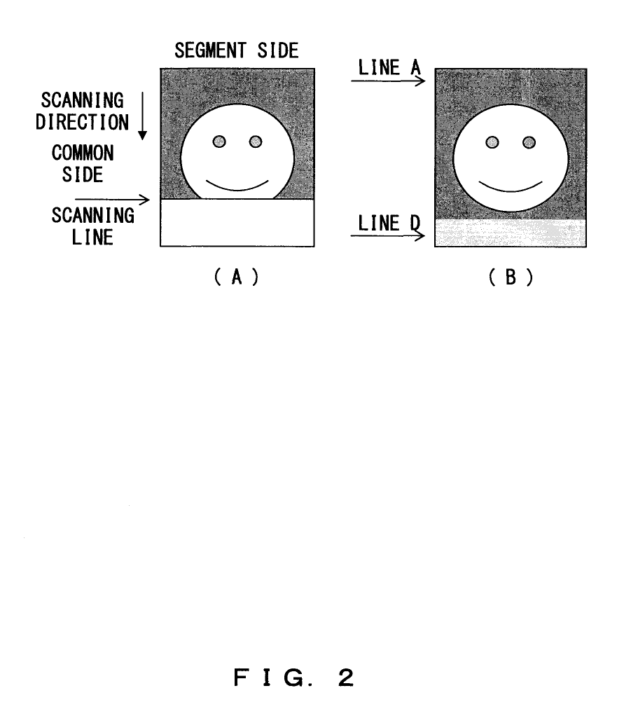

FIG. 2 is an explanatory view of a problem (No. 1) of conventional technology.

Normally, lines are sequentially rewritten one by one from an endmost line to a line on the other end on a common side when an entire screen is displayed.

A selected voltage is normally applied with a scanning line on the common side (see FIG. 2(A)). At this time, a slight color difference (unevenness on a screen) occurs between a portion (line A) selected by the scanning line at the beginning of scanning and a portion (line D) selected by the scanning line at the end of the scanning (see FIG. 2(B)).

2. Color Difference when a Display is Performed after being Partially Rewritten

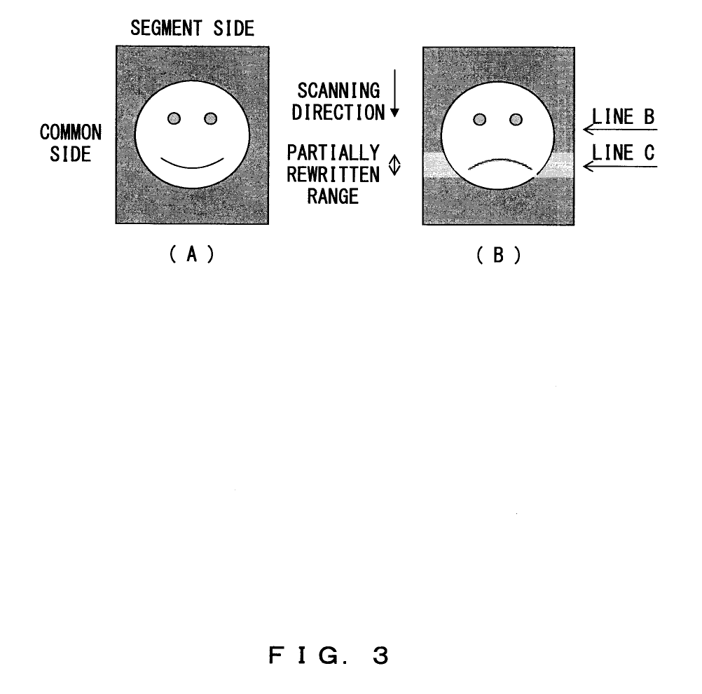

FIG. 3 is an explanatory view of a problem (No. 2) of the conventional technology.

Normally, a drawn image is scanned from end to end of a display panel (see FIG. 3(A)). If only a portion of display contents is changed, only the changed portion is rewritten. At this time, a color difference occurs between the color of a portion (line B) displayed in advance and that of a displayed portion (line C) after being partially rewritten, even though an attempt is made to display the portions in the same color (see FIG. 3(B)). Namely, the color of the portion (line C) displayed later becomes slightly different from that of the portion (line B) displayed immediately before because the portion of the screen is partially rewritten, so that the color of the portion displayed later becomes light. This color difference is more noticeable than the unevenness on the screen of the display panel.

Embodiments of the present invention are described in detail with reference to the drawings.

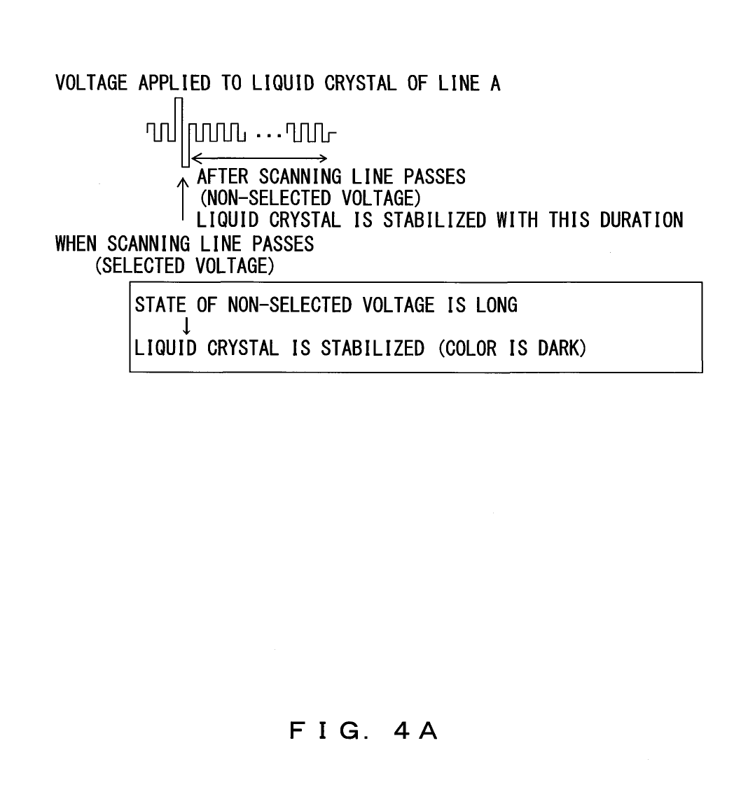

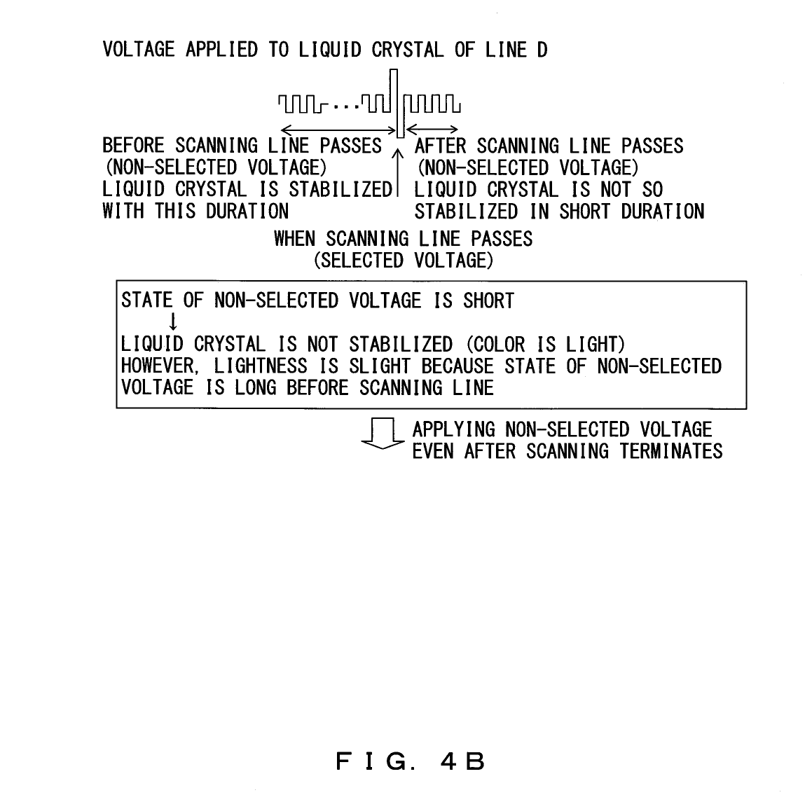

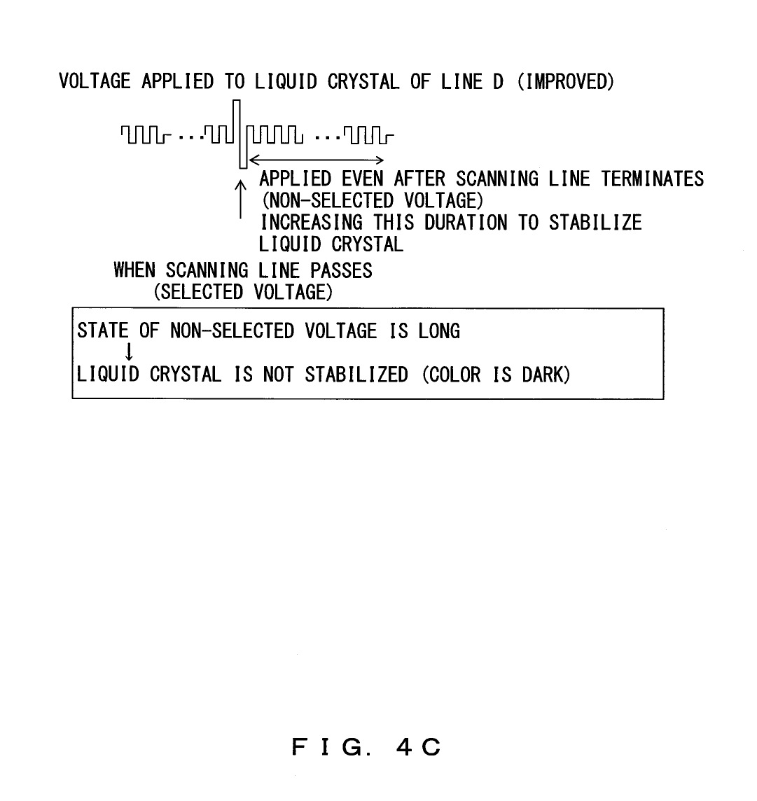

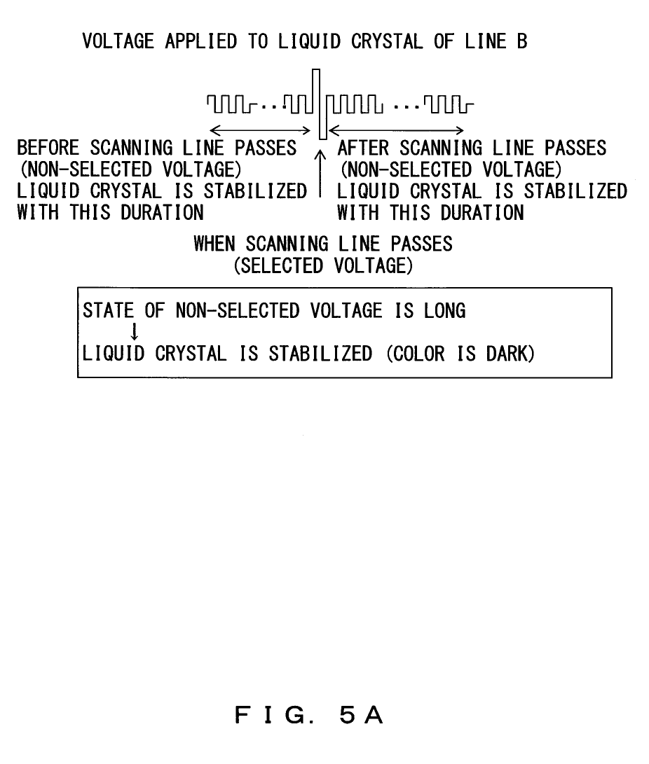

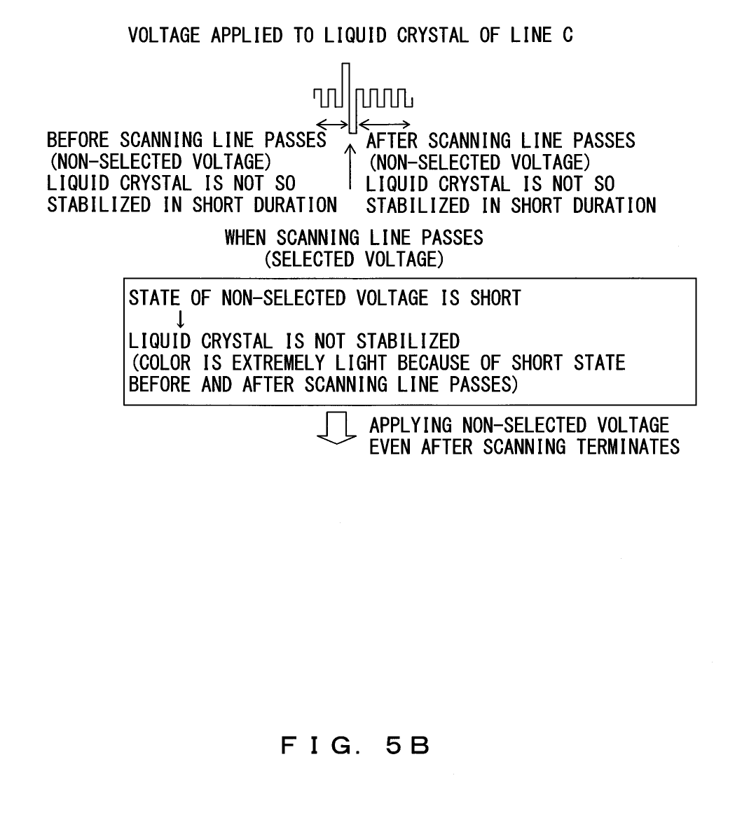

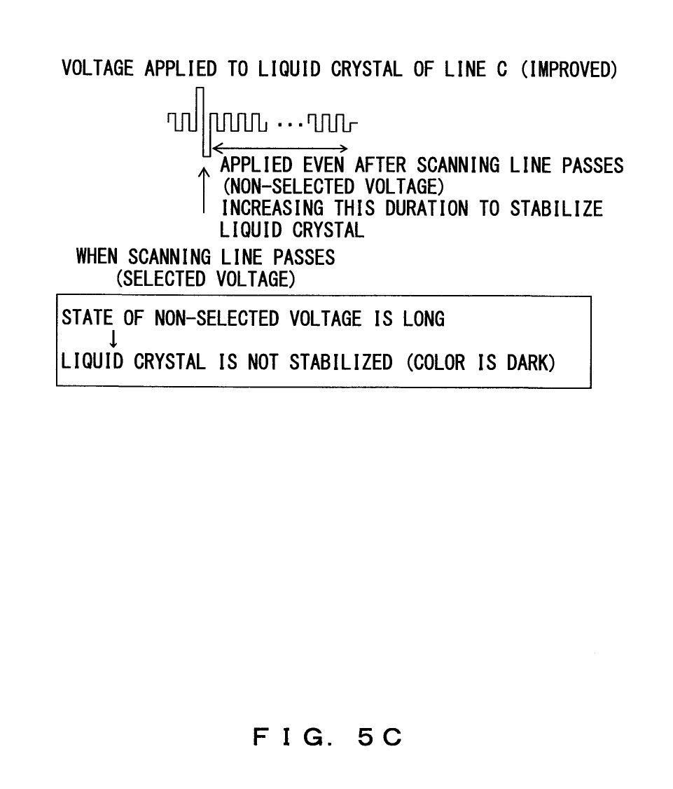

FIGS. 4A, 4B and 4C are explanatory views of a first embodiment to which the present invention is applied.

A nonvolatile liquid crystal display device to which the present invention is applied has a liquid crystal display panel including a scanning signal line group, a data signal line group intersecting the scanning signal line group, and a plurality of pixel circuits arranged at positions where these signal line groups intersect with each other, and containing a nonvolatile liquid crystal compound such as a cholesteric liquid compound or the like as a liquid crystal layer. By sequentially driving the scanning signal line group, the liquid crystal display panel can display an image.

Additionally, a cholesteric liquid crystal has a property of holding a liquid crystal state even if an applied voltage is stopped. Normally, a matrix is controlled with two types of voltages such as a selected voltage (a voltage for implementing the focal conic state) , and a non-selected voltage (a voltage for leaving a state unchanged).

As illustrated in FIG. 4A, for a voltage applied to the liquid crystal of the line A in FIG. 2, a state where the non-selected voltage is applied after the scanning line passes continues relatively long, so that the liquid crystal is stabilized to enable a dark color to be displayed.

However, as illustrated in FIG. 4B, for a voltage applied to the liquid crystal of the line Din FIG. 2, the state where the non-selected voltage is applied after the scanning line passes is relatively short, so that the liquid crystal is not stabilized to display a light color.

Accordingly, as illustrated in FIG. 4C, the non-selected voltage is supplied, for a predetermined duration before and after the selected voltage is supplied, respectively to all of scanning signal lines that configure the scanning signal line group. If the selected voltage is applied for an arbitrary time, the liquid crystal enters the focal conic state. By applying the non-selected voltage before and after applying the selected voltage, the state of the liquid crystal can be stabilized. Namely, the liquid crystal stays in the homeotropic state, close to the focal conic state, while the non-selected voltage is being applied.

By applying the non-selected voltage, for a predetermined duration, to a liquid crystal display panel containing a cholesteric liquid crystal or the like in this way before and after an image is displayed, namely, before and after the selected voltage is applied, an image in a stable color can be displayed, leading to a reduction in unevenness on the screen of the liquid crystal display panel.

FIGS. 5A, 5B and 5C are explanatory views of a second embodiment to which the present invention is applied.

As the second embodiment, a nonvolatile liquid crystal display device to which the present invention is applied supplies the non-selected voltage, for a predetermined duration after the selected voltage is supplied, to a scanning signal line to be partially rewritten at the time of a partial rewrite performed by scanning only a scanning signal line related to a display content to be changed.

As illustrated in FIG. 5A, for a voltage applied to the liquid crystal of the line B in FIG. 3, the state where the non-selected voltage is applied after the scanning line passes continues relatively long, so that the liquid crystal is stabilized to enable a dark color to be displayed.

However, as illustrated in FIG. 5B, for a voltage applied to the liquid crystal of the line C in FIG. 3, the state where the non-selected voltage is applied after the scanning line passes is relatively short. Therefore, the liquid crystal is not stabilized to display a light color.

Accordingly, as illustrated in FIG. 5C, the non-selected voltage is supplied to the scanning signal line to be partially rewritten for a predetermined duration after the selected voltage is supplied.

Similar to the above described first embodiment, the liquid crystal is in the focal conic state by applying the selected voltage for a predetermined duration. By applying the non-selected voltage before and after the selected voltage is applied, the state of the liquid crystal can be stabilized.

Namely, the liquid crystal stays in the homeotropic state, close to the focal conic state, while the non-selected voltage is being applied.

By applying the non-selected voltage for a predetermined duration after a partial rewrite in this way, a color difference from portions except for the partially rewritten portion can be reduced.

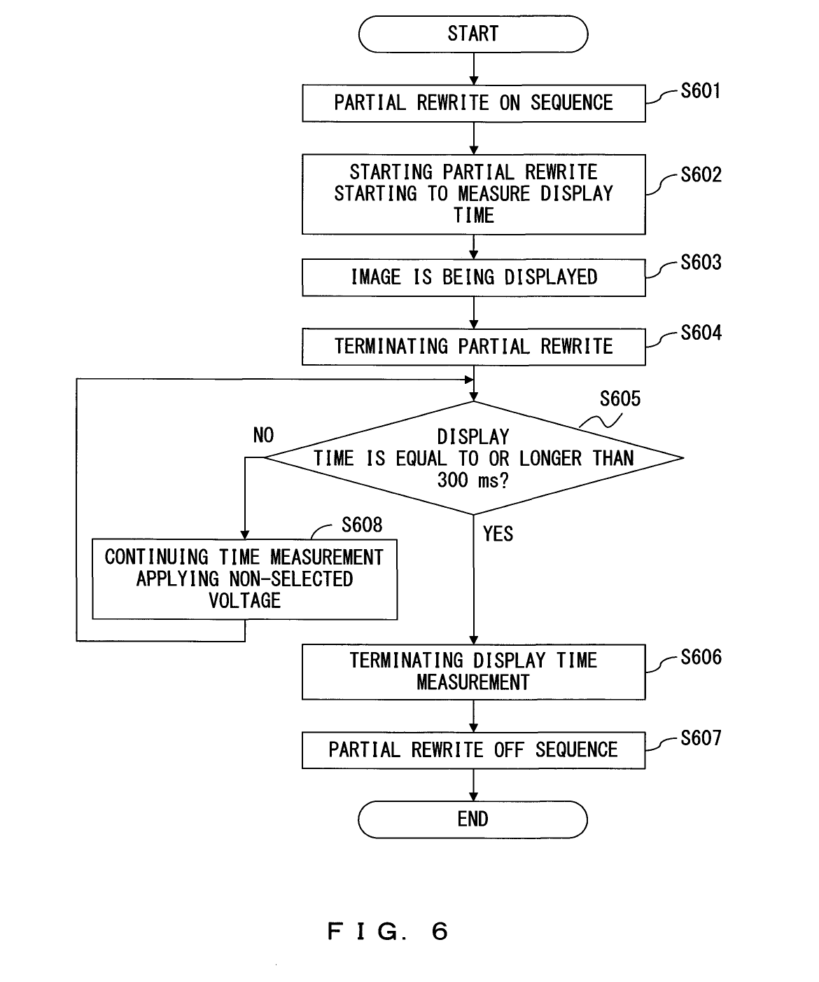

FIG. 6 is a flowchart illustrating a flow of a display control process in the second embodiment to which the present invention is applied.

Initially, when a partial rewrite ON sequence is started in step S601, a counter for measuring a display time is activated in step S602 the same time the partial rewrite sequence is started. Then, in step S603, an image display is performed.

Next, upon termination of the partial rewrite in step S604, whether or not a value of the counter activated in step S602 is equal to or longer than 300 milliseconds (ms) is determined. The reason is that a duration during which the non-selected voltage is applied before a scanning line passes needs to be the total of approximately 300 milliseconds in order to stabilize the state of a liquid crystal. However, the duration during which the non-selected voltage is applied does not always need to be approximately 300 milliseconds. It is desirable to set an optimum time depending on an attribute (viscosity) or the like of the liquid crystal.

If the counter value is equal to or longer than 300 milliseconds (“YES” in step S605), the measurement of the display time is terminated in step S606. Then, in step S607, the partial rewrite sequence is terminated.

In contrast, if the value of the counter activated in step S602 is not equal to or longer than 300 milliseconds (“NO” in step S605), the non-selected voltage is applied while the counter continues to measure the display time instep S608. The flow then goes back to step S605. Then, step S605 and subsequent steps are repeated.

Also the above described first embodiment can be regarded as one form of the partial rewrite performed in the second embodiment.

The embodiments of the present invention have been described above with reference to the drawings. The above described embodiments of the present invention can be implemented with hardware, or firmware or software on a DSP (Digital Signal Processor) board or a CPU board as one function of the nonvolatile liquid crystal display device.

Additionally, the nonvolatile liquid crystal display device to which the present invention is applied is not limited to the above described embodiments as long as the function of the device is implemented. As a matter of course, the nonvolatile liquid crystal display device may be a single device, a system or an integrated unit composed of a plurality of devices. Alternatively, the nonvolatile liquid crystal display device may be a system that executes processes via a network such as a LAN, a WAN or the like.

Still alternatively, the nonvolatile liquid crystal display device can be implemented also with a system composed of a CPU, a memory such as a ROM or a RAM, an input device, an output device, an external recording device, a medium driving device and a network connecting device, which are connected to a bus. Namely, as a matter of course, the nonvolatile liquid crystal display device can be also implemented by providing the nonvolatile liquid crystal display device with the memory such as the ROM or the RAM, the external recording device or a portable recording medium, which records a software program for implementing the above described systems of the embodiments, and by causing a computer of the nonvolatile liquid crystal display device to read and execute the program.

In this case, the program itself read from the portable recording medium or the like implements the new functions of the present invention, and the portable recording medium or the like, which records the program, configures the present invention.

Examples of the portable recording medium for providing the program include a flexible disk, a hard disk, an optical disk, a magneto-optical disk, a CD-ROM, a CD-R, a DVD-ROM, a DVD-RAM, a magnetic tape, a nonvolatile memory card, a ROM card, and various types of recording media recorded via a network connecting device (in other words, a communication line) of electronic mail, a personal computer communication or the like.

Additionally, the above described functions of the embodiments are implemented in a way such that a computer (information processing device) executes the program read in the memory. Alternatively, the functions of the above described embodiments are also implemented with actual processes some or all of which are executed by an OS or the like running on the computer based on an instruction of the program.

Furthermore, the above described functions of the embodiments can be implemented with processes some or all of which are executed by a CPU or the like included in a function extension board or a function extension unit based on an instruction of the program after the program read from the portable recording medium, or the program (data) provided from a program (data) provider is written to a memory included in the function extension board inserted in the computer, or the function extension unit connected to the computer.

Namely, the present invention is not limited to the above described embodiments, and can employ various configurations and forms within a scope that does not depart form the gist of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and the inferiority of the invention. Although the embodiments of the present invention have been described in detail, it should be understood that the various changes, substitutions, and alterations could be made hereto without departing from the spirit and scope of the invention.

What is claimed is:

1. A nonvolatile liquid crystal display device, comprising:
a liquid crystal display panel including a scanning signal line group, a data signal line group intersecting the scanning signal line group, and a plurality of pixel circuits arranged at positions where the signal line groups intersect with each other, and containing a nonvolatile liquid crystal compound as a liquid crystal layer;
a scanning signal line driving unit sequentially driving the scanning signal line group; and
a controlling unit supplying a selected voltage and a non-selected voltage to the scanning signal line driving unit, wherein
the controlling unit supplies the non-selected voltage, for a predetermined duration before and after the selected voltage is supplied, respectively to all of scanning signal lines configuring the scanning signal line group.

2. The nonvolatile liquid crystal display device according to claim 1, wherein
the controlling unit supplies the non-selected voltage, for a predetermined duration after the selected voltage is supplied, to a scanning signal line to be partially rewritten at the time of a partial rewrite performed by scanning only the scanning signal line related to a display content to be changed.

3. The nonvolatile liquid crystal display device according to claim 1, wherein
the liquid crystal layer is a cholesteric liquid crystal layer.

4. A display method for a nonvolatile liquid crystal display device having a liquid crystal display panel including a scanning signal line group, a data signal line group intersecting the scanning signal line group, and a plurality of pixel circuits arranged at positions where the signal line groups intersect with each other, and containing a nonvolatile liquid crystal compound as a liquid crystal layer, a scanning signal line driving unit sequentially driving the scanning signal line group, and a controlling unit supplying a selected voltage and a non-selected voltage to the scanning signal line driving unit, comprising
causing the controlling unit to supply the non-selected voltage, for a predetermined duration before and after the selected voltage is supplied, respectively to all of scanning signal lines configuring the scanning signal line group.

5. The nonvolatile liquid crystal display device display method according to claim 4, wherein
the controlling unit supplies the non-selected voltage, for a predetermined duration after the selected voltage is supplied, to a scanning signal line to be partially rewritten at the time of a partial rewrite performed by scanning only the scanning signal line related to a display content to be changed.

6. The nonvolatile liquid crystal display device display method according to claim 4, wherein
the liquid crystal layer is a cholesteric liquid crystal layer.

7. A nonvolatile liquid crystal display device, comprising:
a liquid crystal display panel including a scanning signal line group, a data signal line group intersecting the scanning signal line group, and a plurality of pixel circuits arranged at positions where the signal line groups intersect with each other, and containing a nonvolatile liquid crystal compound as a liquid crystal layer;
scanning signal line driving means for sequentially driving the scanning signal line group; and
controlling means for supplying a selected voltage and a non-selected voltage to the scanning signal line driving means, wherein
the controlling means supplies the non-selected voltage, for a predetermined duration before and after the selected voltage is supplied, respectively to all of scanning signal lines configuring the scanning signal line group.
